(19) United States
(12) Patent Application Publication
(10) Pub. No.: US 2018/0046719 A1
(43) Pub. Date: Feb. 15, 2018

(54) Displaying Content Associated With a Previous Visit of a Current Asset

(71) Applicant: Prysm, Inc., San Jose, CA (US)

(72) Inventors: Karan M. Gupta, Fremont, CA (US); Ashish Krishna, Hyderabad (IN)

(73) Assignee: Prysm, Inc., San Jose, CA (US)

(21) Appl. No.: 15/237,159

(22) Filed: Aug. 15, 2016

(51) Int. Cl. G06F 17/30

(52) U.S. Cl. CPC G06F 17/30867; G06F 17/30392

(57) ABSTRACT

Various embodiments provide a context-based proactive search that can automatically, in a seamless manner, display or otherwise make available content associated with a previous visit of a current asset. Various embodiments utilize a depository to save information associated with content that has been saved by a user or content in which the user has an implied interest. When the user returns to a particular asset, the depository is automatically searched for content associated with the particular asset that has been saved. A user interface instrumentality is presented and automatically displays the saved content, or indicia of the saved content—termed a “reminder”—from the previous visit. In this manner, the user does not have to physically search for saved content from a previously-visited asset. Rather, the saved content or indicia thereof is automatically presented in a user interface instrumentality that enables the user to select the reminder to quickly and conveniently retrieve saved content.

### BACKGROUND

In contemporary computing environments, users view a lot of content every day and save a lot of information across many different applications. For example, the user may save links, images, text, webpages, and the like while they are browsing in a web browser during one web browsing session. The user may then end the web browsing session and return to another different web browsing session at another time. During their new web browsing session, the user may wish to return to information that was previously saved. The general-purpose way of discovering this saved information is for the user to conduct a search. For example, the user may wish to retrieve a particular piece of content that was saved in an email application, a cloud-based folder, or by way of the web browser. In such instances, the user must conduct a physical search for a specific piece of content that they may remember saving. They may, however, not remember the specific location where the content was saved. Remembering that they saved a piece of content and the location where the user saved the content can thus be a cumbersome task. This is particularly the case where a user may be a prolific content researcher who saves many pieces of content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a context-based proactive search that can automatically, in a seamless manner, display or otherwise make available content associated with a previous visit of a current asset. An “asset” can be considered as any online or electronic resource from which content can be saved. An asset can include, by way of example and not limitation, a webpage or other web-based resource. Various embodiments utilize a depository to save information associated with content that has been saved by a user or content in which the user has an implied interest. When the user returns to a particular asset, the depository is automatically searched for content associated with the particular asset that has been saved. A user interface instrumentality is presented and automatically displays the saved content, or indicia of the saved content—termed a “reminder”—from the previous visit. In this manner, the user does not have to physically search for saved content from a previously-visited asset. Rather, the saved content or indicia thereof is automatically presented in a user interface instrumentality that enables the user to select the reminder to quickly and conveniently retrieve saved content.

### BRIEF DESCRIPTION OF THE DRAWINGS

The same numbers are used throughout the drawings to reference like features.

FIG. 1 illustrates a system in which various principles described herein can be employed in accordance with one or more embodiments.

FIG. 2 illustrates an example application including a sub-window in accordance with one or more embodiments.

FIG. 3 is a flow diagram that describes steps in a method in accordance with one or more embodiments.

FIG. 4 illustrates an example application including a sub-window in accordance with one or more embodiments.

FIG. 5 is a flow diagram that describes steps in a method in accordance with one or more embodiments.

FIG. 6 illustrates an example system that can be used to implement one or more embodiments.

### DETAILED DESCRIPTION

Overview

Various embodiments provide a context-based proactive search that can automatically, in a seamless manner, display or otherwise make available content associated with a previous visit of a current asset. An “asset” can be considered as any online or electronic resource from which content can be saved. An asset can include, by way of example and not limitation, a webpage or other web-based resource, text, files, directories, storage devices, labels, metadata, and the like. Various embodiments utilize a depository to save information associated with content that has been saved by a user or content in which the user has an implied interest. When the user returns to a particular asset, the depository is automatically searched for content associated with the particular asset that has been saved. A user interface instrumentality is presented and automatically displays the saved content, or indicia of the saved content—termed a “reminder”—from the previous visit. In this manner, the user does not have to physically search for saved content from a previously-visited asset. Rather, the saved content or indicia thereof is automatically presented in a user interface instrumentality that enables the user to select the reminder to quickly and conveniently retrieve saved content. In one or more embodiments, there can be different levels of user interaction with the user interface instrumentality. As in the above example, a user may simply see that a reminder exists that indicates that the user has visited and saved something from the asset. The user may also view and scroll through an index of reminders for a particular asset that are presented. This, in and of itself, may provide the user with the necessary content such that they need not click through to open a containing board to retrieve all of the associated content. A board is a visual mechanism that enables a user to track distinct activities of a user relative to an asset and content of the asset. Thus, a board can be thought of as a grouping mechanism that can group content, including different types of content, that has been the subject of some type of user interaction. Alternately or additionally, the user may click the content itself and immediately navigate to the content in, for example, another browser tab. Alternately or additionally, the user may click or otherwise select the board name to view all of the content of the board. This content in its presentation can be scrollable, as described below.

For example, assume that last week a user was on the web investigating recipes from a website named “greatrecipes.com”. During the course of their investigation, the user saved several recipes. The following week, the user remembered that they had been exploring recipes on “greatrecipes.com” and had saved quite a few recipes from the website. Wishing to continue their investigation, the user returns to “greatrecipes.com” and, when they do, a user interface instrumentality is presented and automatically displays the content, or indicia of the content—termed a “reminder”—that was saved during the previous visit. The content or content indicia can include a thumbnail image along with a link to the saved content so that the user can easily select the reminder to access their saved content without having to physically search for the content or remember where the content was saved.

In the discussion that follows, a section entitled “Operating Environment” is provided and describes one environment in which one or more embodiments can be employed. Following this, a section entitled “Example Application and User Interface” is provided and describes an example application and user interface, including a user interface instrumentality in accordance with one or more embodiments. Next, a section entitled “Associating Content with a Board” describes how content can be associated with a board in accordance with one or more embodiments. Following this, a section entitled “Railed Sub-Window”describes how a sub-window can be moved in accordance with one or more embodiments. Last, a section entitled “Example System” describes an example system in accordance with one or more embodiments.

Operating Environment

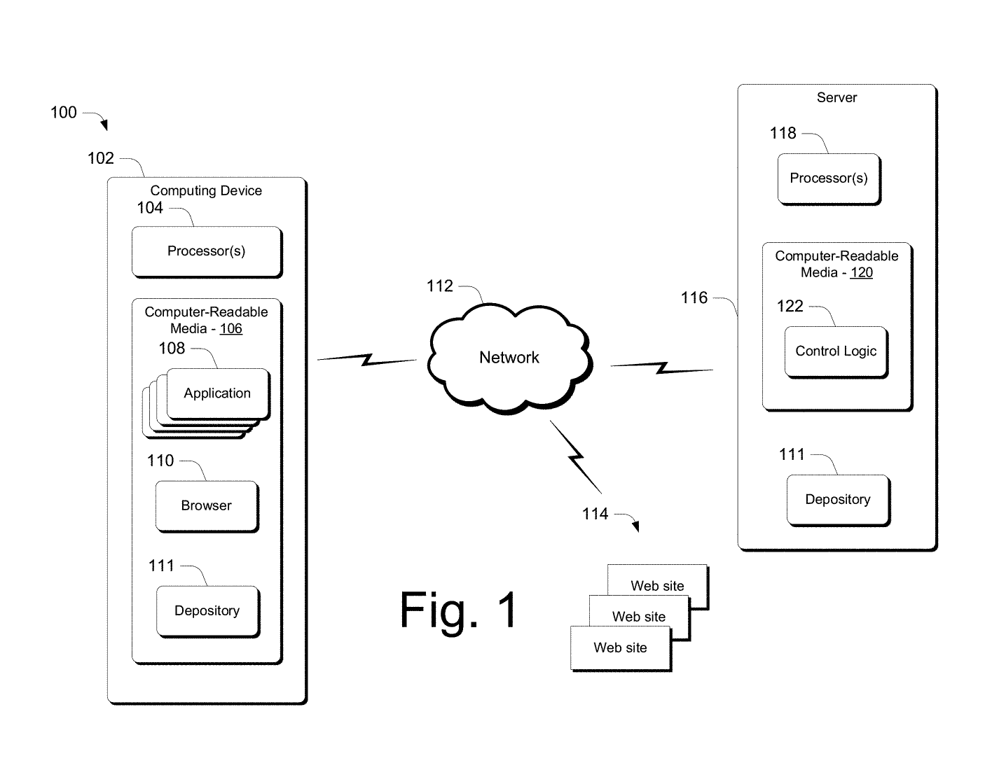

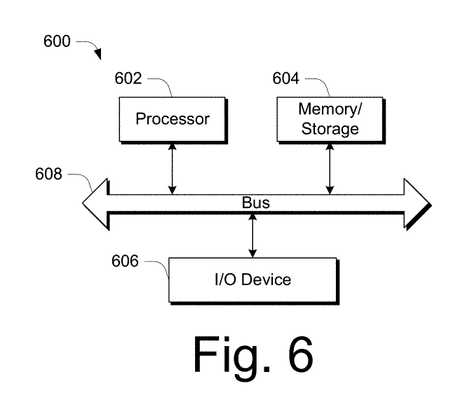

FIG. 1 illustrates an operating environment in accordance with one or more embodiments, generally at 100. Environment 100 includes a computing device 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

In addition, computing device 102 includes a software application in the form of a web browser 110. Any suitable web browser can be used. In at least some embodiments, applications 108 and/or web browser 110 can include functionality that enables a context-based proactive search to be conducted that can automatically, in a seamless manner, display or otherwise make available content associated with a previous visit of a current asset. In at least some embodiments, computing device 102 also includes a depository 111 to save information associated with content that has been saved by a user or content in which the user has an implied interest. The user can save content, or content can be saved for or on behalf of a user, from across multiple different application environments or functional environments. For example, content can be saved from application environments including browser application environments, email application environments, SMS application environments, social media application environments, and the like. Functional environments from which content can be added includes, by way of example and not limitation, file management environments, content curation environments (e.g., photo management environments, music and video management environments), and the like. When the user returns to a particular asset, the depository is automatically searched for content associated with the particular asset that has been saved. A user interface instrumentality is presented and automatically displays the saved content, or indicia of the saved content—termed a “reminder”—from the previous visit. In at least some embodiments, the user interface instrumentality comprises a sub-window that is displayed as part of the user interface of the application or web browser. The sub-window can, in at least some embodiments, run as a separate process within the application 108 or web browser 110. The sub-window is useful in that the user does not have to physically search for saved content from a previously-visited asset. Rather, the saved content or indicia thereof is automatically presented in a user interface instrumentality that enables the user to select the reminder to quickly and conveniently retrieve and interact with the saved content.

In addition, environment 100 includes a network 112, such as the Internet, and one or more web sites 114 from and to which content can be received and sent.

Computing device 102 can be embodied as any suitable computing device such as, by way of example and not limitation, a desktop computer, a portable computer, a handheld computer such as a personal digital assistants (PDA), cell phone, and the like.

In addition, environment 100 includes a server 116 having one or more processors 118, computer readable media 120 embodying control logic 122, and, in at least some embodiments, a depository 111 that is operable as described above and below. The control logic 122 is operable to implement functionality of the inventive embodiments described above and below.

Having considered an example operating environment, consider now an example application including a user interface that includes a user interface instrumentality, as described above.

Example Application and User Interface

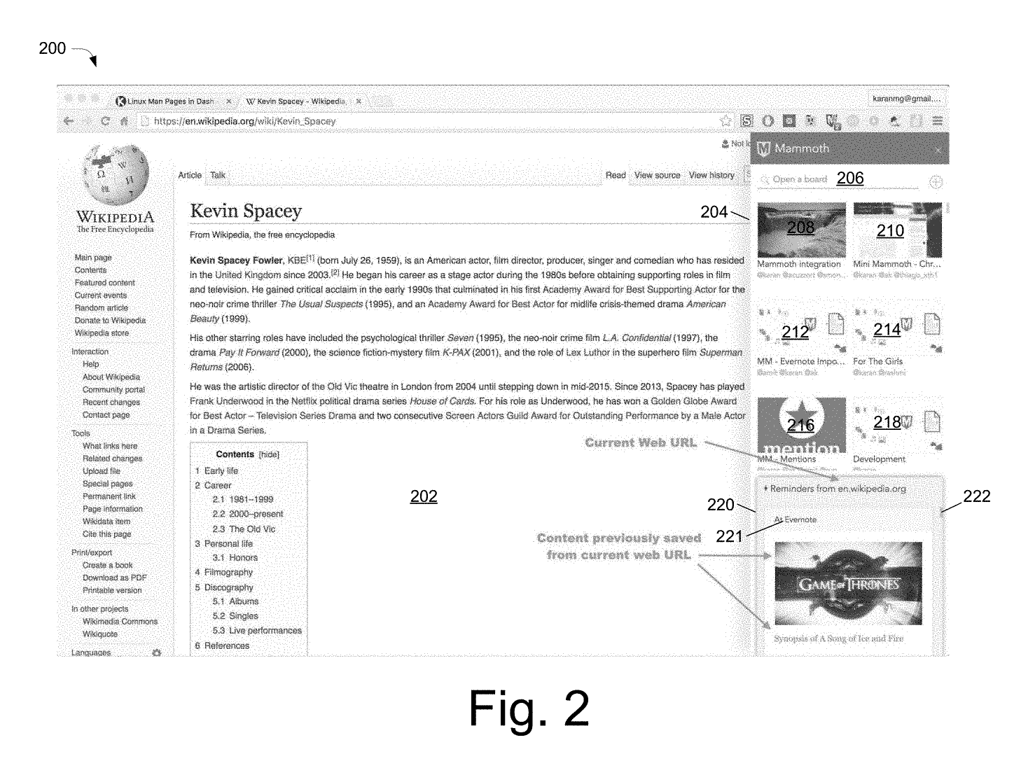

FIG. 2 illustrates an example application with a user interface generally at 200. In this particular example, application 200 is a web browser having multiple tabs. It is to be appreciated and understood, however, that application 200 can comprise any suitable type of application from which content can be saved. Application 200 includes a content rendering area 202 and a scrollable sub-window 204 with a selectable feature 206 to enable the user to open a so-called board. A board is a visual mechanism that enables a user to track distinct activities of a user relative to an asset and content of the asset. Examples of boards appear within sub-window 204 at 208, 210, 212, 214, 216, 218, and 220. The sub-window 204 is scrollable to reveal other boards that have been created but which are not viewable in the current figure. The scrollable sub-window 204 can be implemented as an integral part of application 200. Alternately or additionally, the sub-window 204 can be implemented as an extension to the application 200. The scrollable sub-window 204 can be launched by an icon appearing within a ribbon of application 200. So, for example, if a user browses to an asset of interest, the user can open a new board and begin to collect content within the board. The user can do this, in at least some embodiments, by selecting content and saving the content to the board. For example, the user may drag-and-drop an image, link, or other content onto the board. In browser-based implementations, performance and functionality of the sub-window 204 can be defined through CSS techniques, as will be appreciated by the skilled artisan.

A “board” can be considered as a mechanism that enables activities of the user to be tracked. As noted above, a board is a visual mechanism that enables a user to track distinct activities of a user relative to an asset and content of the asset. Activities can include, by way of example and not limitation, chronological activities of actions the user has performed such as making notes, chats, webpage visits, saving content, importing content such as emails, texts, documents, and the like. Each board is set up to track different activities in which the user may participate. For example, as a user interacts with an asset, the user may select content of the asset and save the content to a board. In tracking activities, the board enables reminders to be collected that are associated with content that the user has added to the board, or content that has been added to the board on behalf of the user. Reminders can then be selected by the user to enable the user to return to the associated content when the user returns to an asset with which the reminders are associated. The user can select a reminder in any suitable way such as, by way of example and not limitation, clicking on a reminder, touch-selecting a reminder, selecting a reminder through a non-touch gesture, and the like. So essentially, a board constitutes a page that has reminders, related to a certain project or specific research activity conducted by a user.

In this instance, boards 208-218 constitute what can be considered as an index of boards that have been created in the past. Interface 220, however, includes an indicia of boards 221 associated with content currently rendered in the content rendering area 202. Interface 220 includes reminders of the content that the user previously visited in a previous session associated with an asset that is the subject of content rendered in content rendering area 202. The reminders can include images, links and the like. Interface 220 also includes a control 222 that allows the interface 220 to be scrolled so that the user can see the additional content or reminders associated with board 221. Each of boards 208-218 can be selected, as by being clicked, touch-selected, or otherwise selected so that the board is expanded to reveal its content or reminders. When the board is expanded, the expanded board can fill the sub-window 204 so that the user can access content or reminders associated with the expanded board.

In the illustrated and described embodiment, interface 220 is associated with content from a particular asset whose content has been saved in previous visits to that asset. Here, the asset is represented by the parent web site name—“en.wikipedia.org”. Thus, in previous visits to this asset, the user has saved or otherwise interacted with content represented within interface 220 as reminders. Now, in a subsequent session, when the user navigates back to the asset or a sub-level within the asset, the depository is automatically searched for content associated with a particular asset that has been saved. In this instance, the user has navigated to a “Kevin Spacey” page within the asset. This page is a sub-level within the “en.wikipedia.org” asset. In response to returning to the asset or a sub-level within the asset, sub-window 204 is presented and automatically displays saved content or reminders associated with this asset from previous visits. The user can then simply scroll through the boards and reminders within interface 220 to access content that was previously saved. A board can also include content such as email threads associated with content with which a user has interacted. For example, the user may have expressed an interest in an asset by including some of the asset's content in an email sent to a friend, e.g., “http://en.wikipedia.org/KevinSpacey is my fav actor” as the body of an email message, with a subject line “Hollywood”. When either the sender or receiver visits a page on “http://en.wikipedia.org”, a proactive search of the depository will be conducted to find relevant content, including content grouped by email threads. In this instance, a reminder “Hollywood” will include:
“http://en.wikipedia.org/KevinSpacey is my fav actor”

In this particular example, the interface 220 that includes content associated with the content currently displayed in content rendering area 202 displays the parent web site name and the content or indicia of the content, i.e. reminders, that have been saved. As noted above, the indicia of content can include a thumbnail image with a link to enable the user to navigate back to the saved content, a link, and other content as well such as files, emails, folders, and the like. So, for example, if a user clicks on or otherwise selects content or content indicia, i.e. a reminder, displayed within interface 220, an immediate navigation will take place to the associated content. In this manner, the user was not required to conduct a search for the previously-visited content or even remember where they may have saved such content. Rather, the reminder was automatically populated within sub-window 204 and, more accurately interface 220, responsive to the user navigating to the content displayed within content rendering area 202.

Now, if the user navigates to a different asset, for example, “youtube.com”, the content of interface 220 will change based on an automatic search of the depository for content that was previously saved from “youtube.com”, and associated reminders will be displayed within interface 220. So, for example, if a user previously saved four videos from “youtube.com”, reminders for those four saved videos will be represented within and accessible to the user by way of presentation within interface 220.

Having considered an example user interface including a sub-window and boards that are displayed within the sub-window, consider now how content can come to be associated with a particular board.

Associating Content with a Board

In one or more embodiments, content of an asset can be associated with a board by first opening a board, such as by using selectable feature 206 to open a new board. As content is displayed within a content rendering area 202, the content can be saved into the newly-opened board in any suitable way. For example, in some embodiments, content can be dragged and dropped into the board. So, if a user is on a particular webpage, the user might select an image or link from the webpage, and drag and drop the image or link into the board. In another embodiment, the user uses a gesture or a button and the image or link from the webpage populates the current active board. That content now becomes part of the board and the content or indicia of the content is automatically saved to the depository as part of the board. As the board is being filled with content, the board fills up the sub-window and as content is placed into the board, it pushes other content in the board upwardly from the bottom up. Content can include other types of content such as files and content from outside the application. For example, the user may have their web browser with an accompanying sub-window pulled up, as well as a file explorer to search files on their computer. In some embodiments, the user can add content from not only the current webpage displayed on their web browser, but content on their local computer as well, such as files from their local device.

In the above example, content was saved into a board by the user expressly saving the content into the board by dragging and dropping the content into the board. In some instances, however, content can become part of a board by ascertaining that a user has an implied interest in the content. For example, assume that a user is browsing content using their web browser. The user comes across an interesting piece of content that they wish to share with a friend. The user selects the content and elects to share the content by emailing it to their friend. If the user has a current board opened, the user's email can become saved to the board such that the next time they navigate to a particular asset associated with the shared content, the user's email and/or email thread can be accessible by way of the board to which it was saved, as discussed in the example above. In this manner, the user would not have to physically search their email application to find the email that they sent to their friend. Similarly, other actions that a user takes can also cause content to become associated with the board. For example, if the user saves content to a cloud-based folder while the board is open, that content and the context under which it was saved can become part of the board. Specifically, the board can include an indication and an instrumentality to enable the user to access the content from the cloud-based folder.

Having considered how content can become associated with a board in accordance with one or more embodiments, consider now an example method in accordance with one or more embodiments.

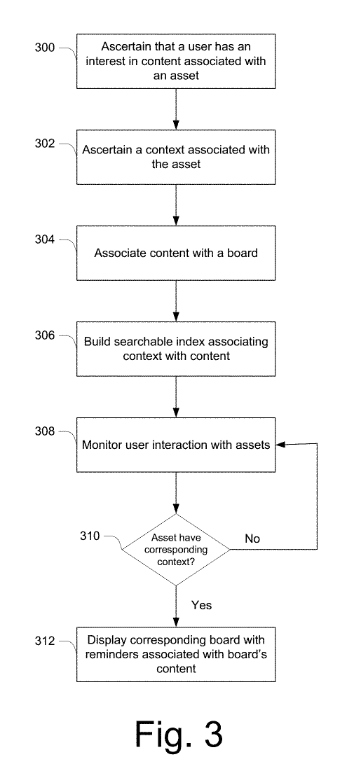

FIG. 3 is a flow diagram that describes steps in a method in accordance with one or more embodiments. The method can be implemented in connection with any suitable hardware, software, firmware or combination thereof. In at least some embodiments, aspects of the method can be implemented by an application, such as a suitably configured web browser.

Step 300 ascertains that a user has an interest in content associated with an asset. This step can be performed in any suitable way. For example, in at least some embodiments, a user can save content associated with the asset to a board, such as the boards described above that are displayed within a sub-window. Alternately or additionally, this step can be performed by ascertaining a user's interest from a user action performed relative to the content. For example, a user may share content with a friend by way of email. Based on sharing the content, the user's interest can be ascertained. Step 302 ascertains a context associated with the asset. The context can comprise any suitable context. For example, in instances where the asset comprises a webpage, the context can comprise a parent website domain name associated with the webpage. Other contexts can be utilized without departing from the spirit and scope of the claimed subject matter. For example, in instances where the asset comprises a project and the content comprises files that are utilized within the project, the context can be the project name.

Step 304 associates the content with a board displayed with the sub-window. This step can be performed by visually associating the content with the board as by enabling the content to be dragged and dropped into the board within the sub-window. Step 306 builds a searchable index or causes a searchable index to be built associating the context with the content. The searchable index can be built locally on the user's local computing device. Alternately or additionally, the searchable index can be caused to be built by transmitting information associated with the context and the content to a server, e.g. server 116 (FIG. 1) which, in turn, builds and maintains the searchable index. In another embodiment the searchable indexes associated with one or more boards may be shared among users. In instances where the asset comprises a webpage, the searchable index would associate the parent website domain name with the content that was associated with the board. Step 308 monitors user interaction with assets. This step can be performed in any suitable way. For example, in at least some embodiments, this step can be performed by monitoring a user's browsing activities by way of their web browser.

Step 310 ascertains whether an asset that is the subject of a user interaction has a corresponding context in the searchable index. That is, in web browsing scenarios, when a user browses to a particular website, this step can be performed by ascertaining whether the parent website domain name appears in the searchable index. In at least some embodiments, this step can be performed by an external process (i.e. external to the application or web browser) tracking one or more application processes. If the searchable index is maintained locally, this step can be performed by searching the locally maintained searchable index. If, on the other hand, the searchable index is maintained by a server, this step can be performed by transmitting information associated with the asset to the server so that the server can ascertain whether the asset has a corresponding context. The transmission of this information can be performed, in at least some embodiments, by the external process. If the asset does not have a corresponding context, the method returns to step 308 to monitor the user's interaction. If, on the other hand, the asset has a corresponding context, e.g., a parent website domain name that appears in the searchable index, step 312 displays a corresponding board within the sub-window with reminders associated with the board's content. The display can represent a chronological display of a user's interaction with a particular asset. Each reminder is associated with content that was saved to the board. Recall that the content can be saved to the board either through an explicit user action, or by ascertaining that the user has an implied interest in the content. Examples of reminders are provided above.

Aspects of the above-described method can be performed either locally on a user's computing device, or remotely by a server. For example, when content is associated with a particular board, a searchable index can be built either locally or remotely. If the index is remote, then when a user interacts with other assets, in some embodiments, the URL of those assets can be transmitted to the server which can then ascertain whether the assets have a corresponding context by searching the index. If so, the server can cause a corresponding board with reminders associated with the board's content to be displayed on the local device. This can be done by transmitting the reminders to the local device so that the reminders can be displayed in a corresponding board.

Having considered an example method in accordance with one or more embodiments, consider now a so-called railed sub-window in accordance with one or more embodiments.

Railed Sub-Window

In various instances, the above-described sub-window may obscure content or activities to be performed within the application's main window. However, to promote the user experience with respect to the sub-window and the utility that it provides with respect to enabling quick and efficient access to previously-visited content, it can be important to maintain the sub-window's size so that the user can easily access individual boards and associated reminders. However, at the same time, it is desirable to enable the user to access visually obscured content that is obscured by the sub-window, or to be able to perform activities that would otherwise be difficult in the presence of the sub-window. Accordingly, in one or more embodiments, the sub-window is movable within the content rendering area while, at the same time, the sub-window maintains its size.

In at least some embodiments, the sub-window is visually fixed to a virtual horizontal rail and is allowed to appear to be slid, left and right, along the rail to expose content underneath as that underneath content is no longer obscured by the sliding sub-window. This can be important to not only enable user to view content underneath the sub-window, but it allows the user to continue to add content to a particular board, as described above, without changing the user experience with respect to the board.

The sub-window can be slid in any suitable way. For example, in at least some embodiments, the sub-window can be slid responsive to mouse events that indicate a mouse down and a move event. Alternately or additionally, the sub-window can be slid responsive to touch, gesture, voice or context dependent events. Alternately or additionally, the sub-window can be moved responsive to a natural user interface gesture such as a non-touch event. In some embodiments the sub-window may slide quickly, slowly or at a variety of speeds. Furthermore, in at least some embodiments, the sub-window can have a transparency function such that as the sub-window is slid, it can become transparent to a degree to allow the user to see what is underneath the sub-window. The sub-window height may vary dependent on the height of the window on which the sub-window slides or based on content within the sub-window or based on other characteristics. This height may vary as the sub-window is slid across the rail. The width of the sub-window may also be dependent upon the content within the sub-window or other parameters either set by the user or pre-defined.

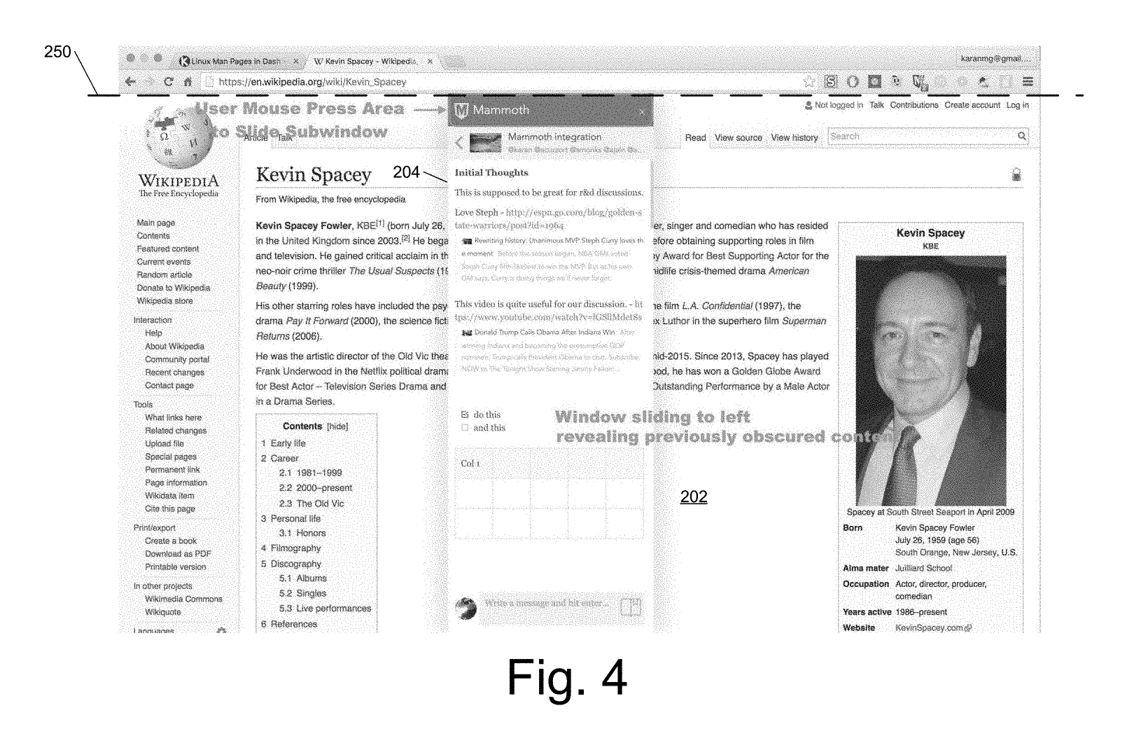

As an example, consider FIG. 4 which shows sub-window 204 within content rendering area 202. A virtual horizontal rail is diagrammatically indicated at 250 and constitutes the top of the viewable area within the content rendering area 202 of the application's current window. In this case, the application is a web browser and virtual horizontal rail 250 constitutes the top of the viewable area within the web browser window. Other application types can employ the techniques described herein such as word processing applications, spreadsheet applications, and the like. In this manner, the top of the viewable area is used as the rail and the sub-window extends up to the top of the viewable area. From a programmatic standpoint, the top of the viewable area within the content rendering area 202 is easily identified such that the sub-window's position can be readily defined relative to the top of the viewable area. In this particular example, the top of the viewable area is identified and an offset of zero relative to the top of the viewable area is utilized to define the virtual horizontal rail. Any suitable offset can be utilized without departing from the spirit and scope of the claimed subject matter. In this particular example, the sub-window's height is defined to extend to the bottom of the viewable area. However, any suitable height can be utilized. In the present example, the sub-window 204 has been slid to the left to reveal content underneath. In this instance, the user can now select the displayed image to add to the board that they are building. Movement of and positioning of the sub-window 204 can be accomplished to the use of CSS techniques which will be understood and appreciated by the skilled artisan.

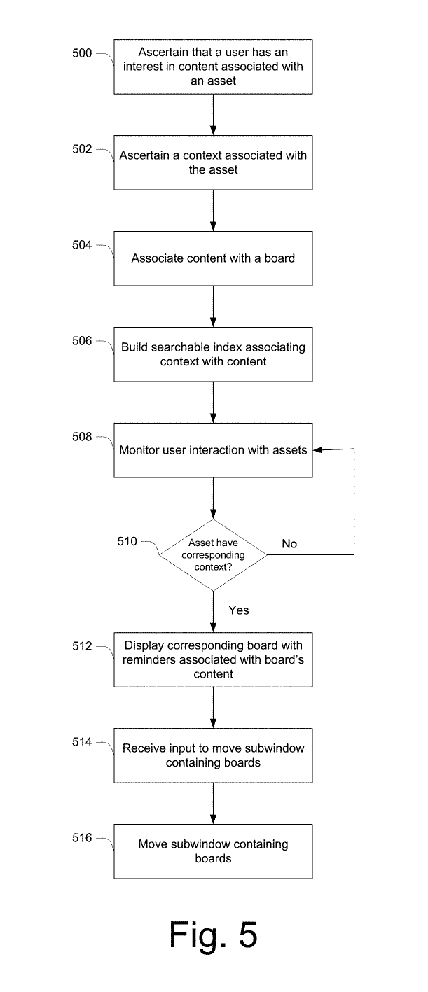

FIG. 5 is a flow diagram that describes steps in a method in accordance with one or more embodiments. The method can be implemented in connection with any suitable hardware, software, firmware or combination thereof. In at least some embodiments, aspects of the method can be implemented by an application, such as a suitably configured web browser.

Step 500 ascertains that a user has an interest in content associated with an asset. This step can be performed in any suitable way. For example, in at least some embodiments, a user can save content associated with the asset to a board, such as the boards described above that are displayed within a sub-window. In one or more embodiments, the sub-window can be placed or positioned relative to a virtual horizontal rail. In the illustrated and described example above, the horizontal rail is located at the top of the viewable area of a content rendering area of an application's current window. In an alternate embodiment, the horizontal rail may be located at the bottom of the viewable area of a content rendering area with or without an offset of an application's current window with the sub-window extending upward from the bottom of the viewable area of a content rendering area. Alternately or additionally, this step can be performed by ascertaining a user's interest from a user action performed relative to the content. For example, a user may share content with a friend by way of email. Based on sharing the content, the user's interest can be ascertained. Step 502 ascertains a context associated with the asset. The context can comprise any suitable context. For example, in instances where the asset comprises a webpage, the context can comprise a parent website domain name associated with the webpage. Other contexts can be utilized without departing from the spirit and scope of the claimed subject matter. For example, in instances where the asset comprises a project and the content comprises files that are utilized within the project, the context can be the project name.

Step 504 associates the content with a board displayed within the sub-window. This step can be performed by visually associating the content with the board as by enabling the content to be dragged and dropped into the board within the sub-window. Step 506 builds a searchable index associating the context with the content. So, for example, in instances where the asset comprises a webpage, the searchable index would associate the parent website domain name with the content that was associated with the board. Step 508 monitors user interaction with assets. This step can be performed in any suitable way. For example, in at least some embodiments, this step can be performed by monitoring a user's browsing activities by way of their web browser.

Step 510 ascertains whether an asset that is the subject of a user interaction has a corresponding context in the searchable index. That is, in web browsing scenarios, when a user browses to a particular website, this step can be performed by ascertaining whether the parent website domain name appears in the searchable index. If the asset does not have a corresponding context, the method returns to step 508 to monitor the user's interaction. If, on the other hand, the asset has a corresponding context, e.g., a parent website domain name that appears in the searchable index, step 512 displays a corresponding board within the sub-window with reminders associated with the board's content. The display can represent a chronological display of a user's interaction with a particular asset. Each reminder is associated with content that was saved to the board. Recall that the content can be saved to the board either through an explicit user action, or by ascertaining that the user has an implied interest in the content. Examples of reminders are provided above.

Step 514 receives input to move the sub-window containing one or more boards. This step can be performed in any suitable way using any suitable type of user input. Responsive to receiving the input, step 516 moves the sub-window containing the boards. This step can be performed by maintaining the size of the sub-window to preserve the user experience with respect to the sub-window and its corresponding boards.

Aspects of the above-described method can be performed either locally on a user's computing device, or remotely by a server. For example, when content is associated with a particular board, a searchable index can be built either locally or remotely. If the index is remote, then when a user interacts with other assets, the URL of those assets can be transmitted to the server which can then ascertain whether the assets have a corresponding context. If so, the server can cause a corresponding board with reminders associated with the board's content to be displayed on the local device. This can be done by transmitting the reminders to the local device so that the reminders can be displayed in a corresponding board.

Having described the embodiments above, consider now an example system that can be utilized to implement one or more of the above-described embodiments.

Example System

FIG. 6 illustrates an example computing device 600 that can implement the various embodiments described above. Computing device 600 can be, for example, computing device 102 of FIG. 1 or any other suitable computing device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more tangible, non-transitory computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available non-transitory medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a context-based proactive search that can automatically, in a seamless manner, display or otherwise make available content associated with a previous visit of a current asset. Various embodiments utilize a depository to save information associated with content that has been saved by a user or content in which the user has an implied interest. When the user returns to a particular asset, the depository is automatically searched for content associated with the particular asset that has been saved. A user interface instrumentality is presented and automatically displays the saved content, or indicia of the saved content, from the previous visit. In this manner, the user does not have to physically search for saved content from a previously-visited asset. Rather, the saved content or indicia thereof is automatically presented in a user interface instrumentality that enables the user to quickly and conveniently retrieve saved content.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
ascertaining, using a computing device, that a user has an interest in content associated with an asset displayed by an application;
ascertaining, using the computing device, a context associated with the asset;
associating, using the computing device, the content with a board that enables user activities relative to the asset to be tracked, the board being configured to have content from different application environments associated with the board;
causing, using the computing device, a searchable index to be built that associates the context with the content;
monitoring, using the computing device, user interaction with one or more assets;
ascertaining, using the computing device, whether an asset that is a subject of a user interaction has a corresponding context in the searchable index;
responsive to ascertaining that the asset that is the subject of the user interaction has a corresponding context, displaying, using the computing device, a corresponding board with reminders associated with the board's content, individual reminders being selectable to enable a user to return to associated content.

2. The computer-implemented method of claim 1, wherein said ascertaining that a user has an interest in content is performed by ascertaining that the user has saved content associated with an asset to a board.

3. The computer-implemented method of claim 2, wherein the board is displayed within a sub-window of the application.

4. The computer-implemented method of claim 1, wherein the application comprises a web browser.

5. The computer-implemented method of claim 1, wherein said ascertaining that a user has an interest in content is performed by ascertaining that the user has performed an action relative to the content other than saving the content to the board.

6. The computer-implemented method of claim 1, wherein the asset comprises a webpage and the context comprises a parent website domain name associated with the webpage.

7. The computer-implemented method of claim 1, wherein said associating the content with the board comprises enabling the content to be dragged and dropped into the board.

8. The computer-implemented method of claim 1, wherein said monitoring user interaction is performed by monitoring a user's browsing activities by way of a web browser.

9. The computer-implemented method of claim 1, wherein said ascertaining whether an asset that is a subject of a user interaction has a corresponding context is performed by transmitting information associated with the asset that is the subject of the user interaction to a server so that the server can ascertain whether there is a corresponding context.

10. One or more non-transitory computer storage media storing computer-readable instructions which, when executed, perform operations comprising:
ascertaining that a user has an interest in content associated with an asset displayed by an application;
ascertaining a context associated with the asset;
associating the content with a board that enables user activities relative to the asset to be tracked;
causing a searchable index to be built that associates the context with the content;
monitoring user interaction with one or more assets;
ascertaining whether an asset that is a subject of a user interaction has a corresponding context in the searchable index;
responsive to ascertaining that the asset that is the subject of the user interaction has a corresponding context, displaying a corresponding board with reminders associated with the board's content, individual reminders being selectable to enable a user to return to associated content.

11. The one or more non-transitory computer storage media of claim 10, wherein said ascertaining that a user has an interest in content is performed by ascertaining that the user has saved content associated with an asset to a board.

12. The one or more non-transitory computer storage media of claim 10, wherein the application comprises a web browser.

13. The one or more non-transitory computer storage media of claim 10, wherein the asset comprises a webpage and the context comprises a parent website domain name associated with the webpage.

14. The one or more non-transitory computer storage media of claim 10, wherein said associating the content with the board comprises enabling the content to be dragged and dropped into the board.

15. The one or more non-transitory computer storage media of claim 10, wherein said monitoring user interaction is performed by monitoring a user's browsing activities by way of a web browser.

16. The one or more non-transitory computer storage media of claim 10, wherein said ascertaining whether an asset that is a subject of a user interaction has a corresponding context is performed by transmitting information associated with the asset that is the subject of the user interaction to a server so that the server can ascertain whether there is a corresponding context.

17. A system comprising:
one or more processors;
one or more computer-readable storage media embodying software instructions which, when executed, implement a method comprising:
ascertaining that a user has an interest in content associated with an asset displayed by an application;
ascertaining a context associated with the asset;
associating the content with a board that enables user activities relative to the asset to be tracked;
causing a searchable index to be built that associates the context with the content;
monitoring user interaction with one or more assets;
ascertaining whether an asset that is a subject of a user interaction has a corresponding context in the searchable index;
responsive to ascertaining that the asset that is the subject of the user interaction has a corresponding context, displaying a corresponding board with reminders associated with the board's content, individual reminders being selectable to enable a user to return to associated content.

18. The system of claim 17, wherein the asset comprises a webpage and the context comprises a parent website domain name associated with the webpage.

19. The system of claim 17, wherein said monitoring user interaction is performed by monitoring a user's browsing activities by way of a web browser.

20. The system of claim 17, wherein said ascertaining that a user has an interest in content is performed by ascertaining that the user has saved content associated with an asset to a board.
